(19) United States
(12) Patent Application Publication
(10) Pub. No.: US 2026/0046585 A1
(43) Pub. Date: Feb. 12, 2026

(54) AUDIO RENDERING METHOD BASED ON RECORDING DISTANCE PARAMETER AND APPARATUS FOR PERFORMING SAME

(71) Applicant: Electronics and Telecommunications Research Institute, Daejeon (KR)

(72) Inventors: Dae Young JANG, Daejeon (KR); Kyeongok KANG, Daejeon (KR); Jae-hyoun YOO, Daejeon (KR); Yong Ju LEE, Daejeon (KR)

(73) Assignee: Electronics and Telecommunications Research Institute, Daejeon (KR)

(21) Appl. No.: 18/872,882

(22) PCT Filed: Jun. 7, 2023
(86) PCT No.: PCT/KR2023/007735

§ 371 Date: Oct. 7, 2025

(30) Foreign Application Priority Data
Jul. 11, 2022 (KR) 10-2022-0085283
May 17, 2023 (KR) 10-2023-0063878

(51) Int. Cl. H04S 7/00

(52) U.S. Cl. CPC H04S 7/303; H04S 7/305; H04S 2400/11; H04S 2400/15

(57) ABSTRACT

An audio rendering method and an apparatus for performing the same are disclosed. An audio rendering method according to an embodiment includes obtaining a first distance related to recording of an audio signal related to an audio object, obtaining a second distance that is a distance between the audio object and a listener, and rendering the audio signal by applying an effect caused by attenuation due to air sound-absorption based on the first distance and the second distance.

### TECHNICAL FIELD

The following description relates to a method of rendering an audio based on a recording distance parameter and an apparatus for performing the same.

### BACKGROUND ART

Audio services have developed from mono and stereo services through 5.1 and 7.1 channels to multichannel services such as 9.1, 11.1, 10.2, 13.1, 15.1, and 22.2 channels. Unlike conventional channel-based audio services, object-based audio service technology that regards one sound source as an object is being developed. The object-based audio service may store, transmit, and play back an object audio signal and information related to object audio (e.g., an object audio position and an object audio size).

Information required when rendering an object-based audio signal includes a relative angle and distance between an audio object and the listener, and in some cases, the object-based audio signal is rendered by additionally using acoustic spatial information. This is because acoustic spatial information is information that allows acoustic transmission characteristics according to space to be better realized. Implementing the acoustic transmission characteristics in detail using the acoustic spatial information and rendering the object-based audio signal may require very complex calculations. A method of rendering the object-based audio signal by dividing the object-based audio signal into direct sound, early reflections, and late reverberations has been proposed to easily implement the sound transmission characteristics according to space.

The above description has been possessed or acquired by the inventor(s) in the course of conceiving the present disclosure and is not necessarily an art publicly known before the present application is filed.

### DISCLOSURE OF THE INVENTION

### Technical Goals

Embodiments may provide a rendering technique that may prevent an effect caused by attenuation due to air sound-absorption from being applied overlappingly between a sound source and a recording distance by introducing a parameter related to the recording distance.

However, technical goals are not limited to the foregoing goals, and there may be other technical goals.

### Technical Solutions

An audio rendering method according to an embodiment includes obtaining a first distance related to recording of an audio signal related to an audio object, obtaining a second distance that is a distance between the audio object and a listener, and rendering the audio signal by applying an effect caused by attenuation due to air sound-absorption based on the first distance and the second distance.

The rendering may include calculating a third distance based on a difference between the first distance and the second distance and rendering the audio signal by applying the effect caused by the attenuation due to the air sound-absorption based on the third distance.

The calculating of the third distance may include calculating the third distance by reducing the second distance by the first distance.

The calculating of the third distance may include calculating the third distance differently based on the difference between the first distance and the second distance.

The calculating of the third distance differently may include calculating the third distance as a predetermined value when the second distance is less than or equal to the first distance, and calculating the third distance by reducing the second distance by the first distance when the second distance is greater than the first distance.

The first distance may include a distance between a sound source to be recorded and a recording apparatus.

The rendering may include rendering the audio signal by compensating for tone by a size of the effect caused by the attenuation due to the air sound-absorption, when the second distance is less than the first distance.

An audio rendering apparatus according to an embodiment includes a memory configured to store instructions, and a processor electrically connected to the memory and configured to execute the instructions, wherein the processor is configured to control a plurality of operations, when the instructions are executed by the processor, wherein the plurality of operations may include obtaining a first distance related to recording of an audio signal related to an audio object, obtaining a second distance that is a distance between the audio object and a listener, and rendering the audio signal by applying an effect caused by attenuation due to air sound-absorption based on the first distance and the second distance.

The rendering may include calculating a third distance based on a difference between the first distance and the second distance and rendering the audio signal by applying the effect caused by the attenuation due to the air sound-absorption based on the third distance.

The calculating of the third distance may include calculating the third distance by reducing the second distance by the first distance.

The calculating of the third distance may include calculating the third distance differently based on the difference between the first distance and the second distance.

The calculating of the third distance differently may include calculating the third distance as a predetermined value when the second distance is less than or equal to the first distance, and calculating the third distance by reducing the second distance by the first distance when the second distance is greater than the first distance.

The first distance may include a distance between a sound source to be recorded and a recording apparatus.

The rendering may include rendering the audio signal by compensating for tone by a size of the effect caused by the attenuation due to the air sound-absorption, when the second distance is less than the first distance.

### BRIEF DESCRIPTION OF DRAWINGS

FIG. 1 is a block diagram illustrating an overview of components of a renderer according to an embodiment.

FIG. 2 is a diagram illustrating an encoder structure of a renderer shown in FIG. 1.

FIG. 3 is a diagram illustrating renderer operations of a renderer module of a renderer shown in FIG. 1.

FIG. 4 is a diagram illustrating the relationship between a recording distance and an attenuation effect due to air sound-absorption.

FIG. 5 is a diagram illustrating an embodiment of calculating a distance for application of an air sound-absorption effect.

FIG. 6 is a diagram illustrating an embodiment of calculating a distance for application of an air sound-absorption effect considering a recording distance.

FIGS. 7 and 8 are diagrams illustrating methods of calculating a distance (e.g., a third distance) for application of an air sound-absorption effect according to an embodiment.

FIG. 9 illustrates the spectrum of an audio signal before and after application of an audio rendering method according to an embodiment.

FIG. 10 is a flowchart illustrating a method of rendering an audio signal, according to an embodiment.

FIG. 11 is a schematic block diagram of an apparatus according to an embodiment.

### BEST MODE FOR CARRYING OUT THE INVENTION

The following detailed structural or functional description is provided as an embodiment only and various alterations and modifications may be made to embodiments. Here, embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms used herein including technical or scientific terms have the same meaning as commonly understood by one of ordinary skill in the art to which embodiments belong. Terms, such as those defined in commonly used dictionaries, should be construed to have meanings matching with contextual meanings in the relevant art and the present disclosure, and are not to be construed as an ideal or excessively formal meaning unless otherwise defined herein.

As used in this disclosure, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

The term “unit” or the like used herein may refer to a software or hardware component, such as a field-programmable gate array (FPGA) or an ASIC, and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionality provided by the components and “units” may be combined into fewer components and “units” or further separated into additional components and “units”. Furthermore, the components and “units” may be implemented to operate on one or more central processing units (CPUs) within a device or a security multimedia card. In addition, “unit” may include one or more processors.

Hereinafter, embodiments will be described in detail with reference to the accompanying drawings. When describing the embodiments with reference to the accompanying drawings, regardless of drawing numerals, like reference numerals refer to like elements and a repeated description related thereto will be omitted.

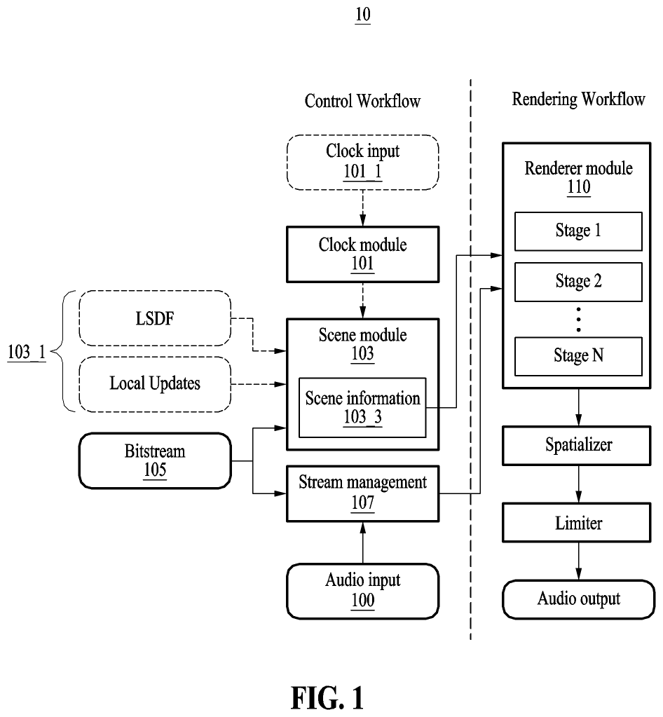

FIG. 1 is a block diagram illustrating an overview of components of a renderer according to an embodiment.

Referring to FIG. 1, according to an embodiment, a renderer 10 may be a moving picture experts group (MPEG)-I immersive audio standard renderer. MPEG is in the process of standardizing MPEG-I immersive audio, which is a standard for rendering an audio signal in a six degrees of freedom (6DoF) virtual reality (VR) environment. In a standard, a metadata bitstream and real-time rendering technology for effectively rendering an audio signal in the 6DoF VR environment are included in the scope of standardization.

As audio in the 6DoF VR environment, channel-based audio, object-based audio, and scene-based audio are used. Contributions were made to metadata and real-time rendering technology for audio signals of the above audio in the 6DoF VR environment to be rendered well, an early version of the MPEG-I immersive audio standard renderer (e.g., the reference model 0 (RM0)) was selected as a standard, and core experiments (CEs) are in progress.

The MPEG-I immersive audio standard renderer may include a control unit and a rendering unit. The control unit may include a clock module 101, a scene module 103, and a stream management module 107. The rendering unit may include a renderer module 110, a spatializer, and a limiter. The MPEG-I immersive audio standard renderer may render an object-based audio signal (hereinafter, referred to as an object audio signal).

The MPEG-I immersive audio standard renderer may provide an interface with external systems and components through the control unit.

The clock module 101 may receive a clock input 101_1 as an input. The clock input 101_1 may include synchronization signals with an external module and/or a reference time of the renderer itself (e.g., a renderer internal clock). The clock module 101 may output current time information of a scene to the scene module 103.

The scene module 103 may process all internal or external scene information changes. The scene module 103 may use information received from the external interface of the renderer (e.g., a listener space description format (LSDF) and listener location and dynamic update information 103_1 (local updates)) and information transmitted by a bitstream 105 (e.g., scene updates information) as inputs. The scene module 103 may include a scene information module 103_3. The scene information module 103_3 may update the current state of all metadata (e.g., acoustic elements and physical objects) related to 6DoF rendering of a scene. The scene information module 103_3 may output current scene information to the renderer module 110.

The stream management module 107 may provide an interface for inputting an acoustic signal (e.g., an audio input 100) for acoustic elements of the scene information module 103_3. The audio input 100 may be a pre-encoded or decoded sound source signal, a local sound source, or a remote sound source. The stream management module 107 may output the acoustic signal to the renderer module 110. The renderer module 110 may render the acoustic signal received from the stream management module 107 using the current scene information. The renderer module 110 may include renderer operations for processing rendering parameters and signal processing of the acoustic signal (e.g., a render item) to be rendered.

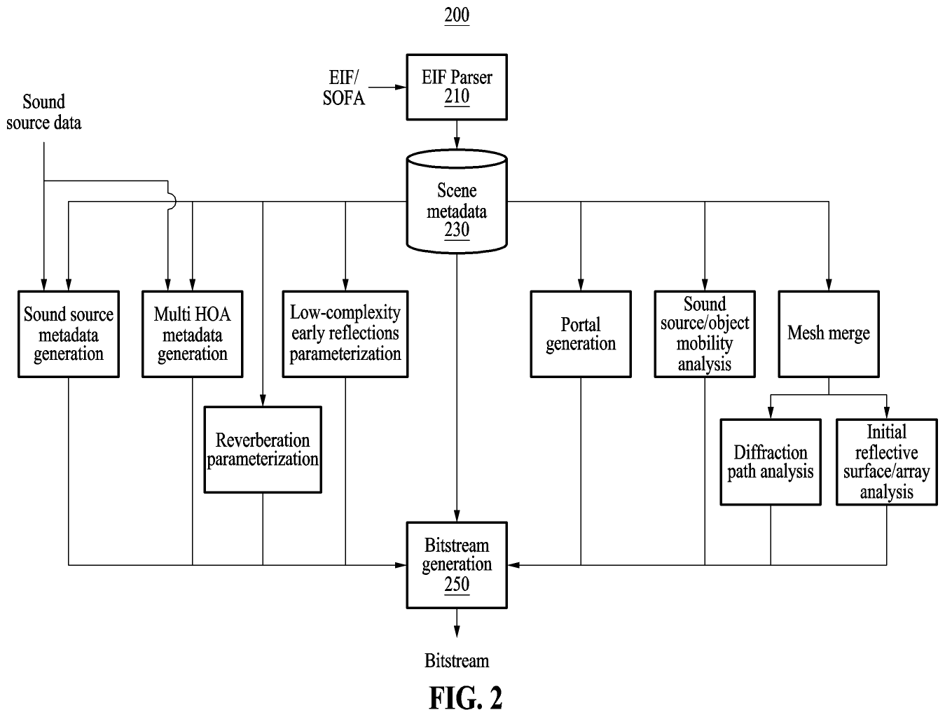

FIG. 2 is a diagram illustrating an encoder structure of a renderer shown in FIG. 1.

Referring to FIG. 2, according to an embodiment, a renderer (e.g., the renderer 10 of FIG. 1) may include an encoder (e.g., an encoder 200). The encoder 200 may include an encoder input format (EIF) parser module 210, a scene metadata module 230, and a bitstream generation module 250. The EIF parser module 210 may receive directivity information of EIF, which is a common input format of an MPEG-I immersive audio encoder, and/or a spatial oriented format for audio (SOFA) format as an input. The EIF parser module 210 may analyze the information of the EIF and/or SOFA format to extract elements (e.g., geometrical structure information of spaces, sound source information (e.g., position, shape, and directivity of a sound source), acoustic characteristic information of materials and spaces, and updated information (e.g., motion information)) constituting scene information of a content.

The scene metadata module 230 may include a sound source metadata generation module, a multi higher order ambisonics (HOA) metadata generation module, a reverberation parameterization n module, a low-complexity early reflections parameterization module, a portal generation module, a sound source/object mobility analysis module, a mesh merge module, a diffraction path analysis module, and an initial reflective surface and array analysis module.

The bitstream generation module 250 may generate a bitstream by receiving metadata generated by each module of the encoder 200 and directivity information of a SOFA file, and by quantizing and multiplexing.

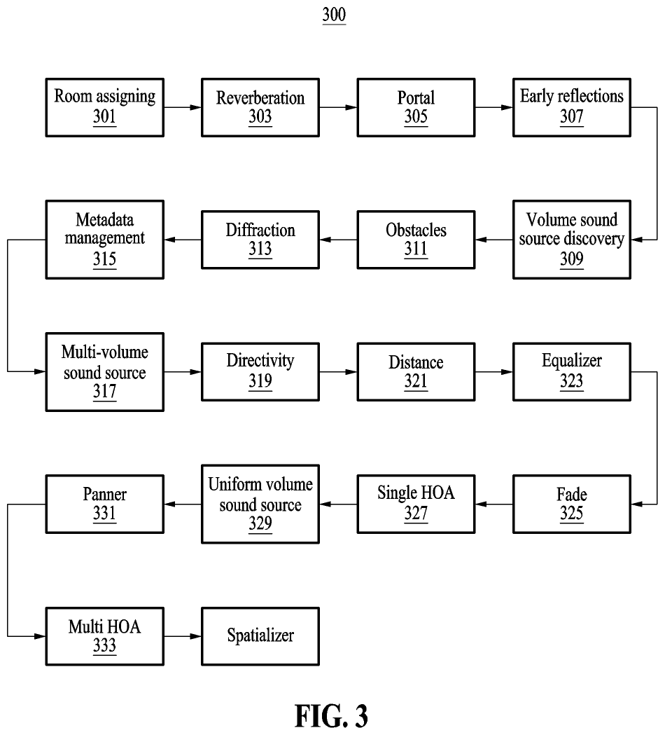

FIG. 3 is a diagram illustrating renderer operations of a renderer module.

Referring to FIG. 3, according to an embodiment, FIG. 3 may be a diagram illustrating renderer operations of the renderer module 110 shown in FIG. 1. Each renderer operation may be executed in a predetermined order. At each renderer operation, render items may be selectively activated or deactivated. Each renderer operation may render an activated render item. Hereinafter, each renderer operation of the renderer module 110 is described.

When a listener enters a room containing acoustic environment information, a room assigning stage 301 may be an operation of applying metadata of the acoustic environment information about the room in which the listener enters to each render item.

A reverberation stage 303 may be an operation of generating reverberation according to acoustic environment information of a current space (e.g., the room containing acoustic environment information). The reverberation stage 303 may be an operation of receiving a reverberation parameter from a bitstream (the bitstream 105 of FIG. 1), attenuating a feedback delay network (FDN) reverberator, and initializing a delay parameter.

A portal stage 305 may be an operation of modeling a sound transmission path. Specifically, the portal stage 305 may be an operation of modeling a partially opened sound transmission path (e.g., a portal) between spaces with different acoustic environment information on late reverberation. In acoustics, a portal is an abstract concept that models transmission of sound from one space to another through a geometrically defined open part. The portal stage 305 may be an operation of modeling an entire space where a sound source is located as a uniform volume sound source. The portal stage 305 may be an operation of considering a wall as an obstacle according to shape information of the portal included in the bitstream 105 and rendering the render item as a uniform volume sound source.

An early reflections stage 307 is an operation in which a rendering method may be selected considering rendering quality and computational quantity. The early reflections stage 307 may be omitted. The rendering method that may be selected in the early reflections stage 307 may include a high-quality early reflections rendering method and a low-complexity early reflections rendering method. The high-quality early reflections rendering method may be a method of calculating early reflection sound by determining the visibility of an image source related to an early reflection wall causing early reflection included in the bitstream 105. The low-complexity early reflections rendering method may be a method of replacing an early reflection section using predefined simple early reflection patterns.

A volume sound source discovery stage 309 may be an operation of finding a point where sound lines that radiate in all directions intersect with each portal or volume source, in order to render a sound source (e.g., a volume sound source) having a spatial size including a portal. Information found in the volume sound source discovery stage 309 (e.g., an intersection of the sound lines and the portal) may be output to an obstacles stage 311 and a uniform volume sound source stage 329.

The obstacles stage 311 may provide information of an obstacle on a straight path between the sound source and the listener. The obstacles stage 311 may be an operation of updating a status flag for fade in-out processing at a boundary of the obstacle and an equalizer (EQ) parameter based on the transmittance of the obstacle.

A diffraction stage 313 may be an operation of generating information necessary for generating a diffracted sound source transmitted to the listener from the sound source blocked by the obstacle. For a fixed sound source, a pre-calculated diffraction path may be used to generate information. For a moving sound source, a diffraction path calculated from a potential diffraction edge may be used to generate information.

When the render item is distance attenuated or attenuated below an audible range by the obstacle, a metadata management stage 315 may be an operation of deactivating the attenuated render item to reduce the computational quantity in subsequent operations.

A multi-volume sound source stage 317 may be an operation of rendering the sound source including a plurality of sound source channels and having a spatial size.

A directivity stage 319 may be an operation of applying a directivity parameter (e.g., a gain per band) for the current direction of the sound source to a render item in which directivity information is defined. The directivity stage 319 may be an operation of additionally applying the gain per band to an existing EQ value.

A distance stage 321 may be an operation of applying the effects of a delay due to the distance between the sound source and the listener, distance attenuation, and attenuation due to air sound-absorption. The distance stage 321 may be an operation of applying a propagation delay to a signal associated with the render item to generate a physically accurate delay and Doppler effect. The distance stage 321 may be an operation of modeling frequency independent attenuation of an audio element due to geometric diffusion of sound source energy by applying the distance attenuation. The distance stage 321 may be an operation of applying an effect according to medium absorption to an object audio signal by modeling frequency dependent attenuation of the audio element related to the air sound-absorption characteristic. The distance stage 321 may be an operation of calculating the distance between the listener and an audio object by using the positions of the listener and the audio object. The distance stage 321 may be an operation of determining a gain of the object audio signal by applying the distance attenuation according to the distance between the audio object and the listener.

An EQ stage 323 may be an operation of applying a finite impulse response (FIR) filter to the gain values for each frequency band accumulated by obstacle transmission, diffraction, early reflection, directivity, distance attenuation, and the like.

A fade stage 325 may be an operation of reducing discontinuous distortion that may occur when the activation of the render item changes or when the listener suddenly moves in space, through fade in-out processing.

A single HOA stage 327 may be an operation of rendering a background sound by one HOA sound source. The single HOA stage 327 may be an operation of converting a signal of an equivalent spatial domain (ESD) format input from the bitstream 105 into HOA and converting the HOA into a binaural signal through a magnitude least squares (MagLS) decoder. That is, the single HOA stage 327 may be an operation of converting an input audio into HOA and spatially combining and converting signals through HOA decoding.

The uniform volume sound source stage 329 may be an operation of rendering a sound source (e.g., a uniform volume sound source) having a spatial size and a single characteristic. The uniform volume sound source stage 329 may be an operation of mimicking the effects of numerous sound sources in a volume sound source space through a decorrelated stereo sound source. When the effect of the sound source is partially blocked by the obstacle, the uniform volume sound source stage 329 may be an operation of generating the effect of the sound source blocked based on information from the obstacles stage 311.

A panner stage 331 may be an operation of rendering multi-channel reverberation. The panner stage 331 may be an operation of rendering the audio signal of each channel to head-tracking based global coordinates based on the vector-based amplitude panning (VBAP).

A multi HOA stage 333 may be an operation of generating 6DoF sound of content in which two or more HOA sound sources are simultaneously used. That is, the multi HOA stage 333 may be an operation of 6DoF rendering the HOA sound sources with respect to the position of the listener using information on a spatial metadata frame. An output of 6DoF rendering the HOA sound sources may be the 6DoF sound. Like the single HOA stage 327, the multi HOA stage 333 may be an operation of converting and processing an ESD format signal into HOA.

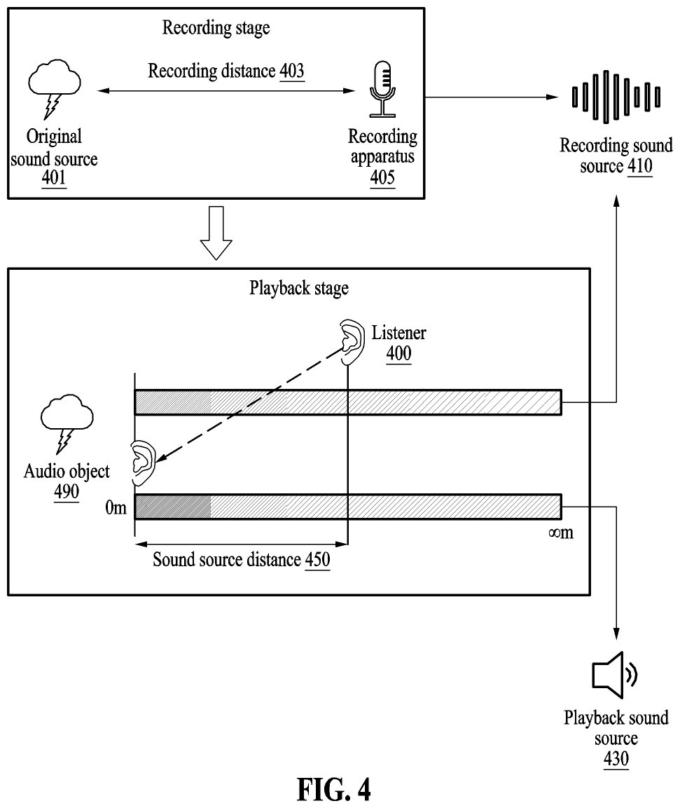

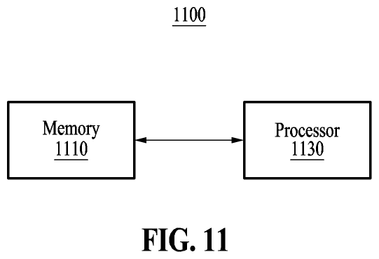

Hereinafter, with reference to FIGS. 4 to 11, an audio rendering method and an apparatus for performing the same according to an embodiment are described. According to an embodiment, an apparatus 1100 of FIG. 11 may perform the audio rendering method. The apparatus 1100 may include a renderer (e.g., the renderer 10 of FIG. 1).

FIG. 4 is a diagram illustrating the relationship between a recording distance and an attenuation effect due to air sound-absorption.

Referring to FIG. 4, according to an embodiment, the apparatus 1100 may render an audio signal. The apparatus 1100 may determine gain, propagation delay, and medium absorption of an object audio signal based on a distance between an audio object (e.g., an audio object 490) and a listener (e.g., a listener 400) in a rendering unit (e.g., the rendering unit of FIG. 1). For example, in a distance stage (e.g., the distance stage 321 of FIG. 3) of a renderer module (e.g., the renderer module 110 of FIG. 1), the apparatus 1100 may determine at least one of the gain, propagation delay, and medium absorption of the object audio.

The apparatus 1100 may calculate the distance between each render item and the listener in the distance stage 321 and may interpolate the distance between calls to the update routine of an object audio stream based on a constant velocity model. The render item may refer to all audio elements in a rendering process. The apparatus 1100 may apply the propagation delay to a signal associated with the render item to generate a physically accurate delay and Doppler effect. The apparatus 1100 may model frequency independent attenuation of an audio element due to geometric diffusion of source energy by applying distance attenuation. The apparatus 1100 may use a model considering the size of a sound source for the distance attenuation of a geometrically diffusing sound source. The apparatus 1100 may apply the medium absorption to the object audio signal by modeling frequency dependent attenuation of the audio element related to the air sound-absorption characteristic. The apparatus 1100 may determine the gain of the object audio signal by applying the distance attenuation according to the distance (e.g., a sound source distance 450) between the audio object 490 and the listener 400. The apparatus 1100 may apply the distance attenuation due to the geometric diffusion of the sound source energy using a parametric model considering the size of the sound source. When playing audio in a 6DoF environment, the sound level of the audio object may vary depending on the distance (e.g., the sound source distance 450), and the sound level of the object audio signal may be determined according to the 1/r rule (where r is the distance between the audio object and the listener), where the sound level decreases in inverse proportion to the distance. For example, the apparatus 1100 may determine the sound level of the object audio signal according to the 1/r rule in an area where the distance between the audio object 490 and the listener 400 is greater than the minimum distance and less than the maximum distance. The minimum distance and the maximum distance may refer to distances set for the application of attenuation according to the distance, propagation delay, and air sound-absorption effects. For example, the apparatus 1100 may use metadata to identify the position of the listener 400 (e.g., three-dimensional (3D) spatial information), the position of the audio object 490 (e.g., 3D spatial information), the speed of the audio object 490, and the like. The apparatus 1100 may calculate the distance between the listener 400 and the audio object 490 (e.g., the sound source distance 450) using the position of the listener 400 and the position of the audio object 490. The size of the audio signal transmitted to the listener 400 may change according to the sound source distance 450. For example, the sound level transmitted to a listener located 2 meters (m) away from an audio source (e.g., the position of the audio object 490) may be less than the sound level transmitted to a listener located 1 m away. The sound level in a free sound-field environment is reduced at a rate of 1/r, but when the distance between the audio object and the listener is doubled, the sound level heard by the listener may decrease by about 6 decibels (dB). The rule of attenuation of distance and sound level may also be applied in the 6Dof VR environment. The apparatus 1100 may use a method of reducing the sound level of the object audio signal for one audio object when the distance is far from the listener and increasing the sound level when the distance is near. For example, assuming that the sound pressure level of the sound heard by the listener 400 is 0 dB when the listener 400 is 1 m away from the audio object 490, and when the listener 400 moves away from the audio object 490 by 2 m, if the sound pressure level changes to −6 dB, there may be a feeling that the sound pressure naturally decreases. When the distance between an audio object and a listener is greater than the minimum distance and less than the maximum distance, the apparatus 1100 may determine the gain of the object audio signal according to Equation 1 below.

$$Gain [ dB ] = 20 log ( reference distance / current distance ) \qquad [ Equation 1 ]$$

Here, reference distance may denote a standard distance and current distance may denote a distance between an audio object and a listener.

The reference distance may denote the distance at which the gain of the object audio signal becomes 0 dB and may be set differently for each audio object. The reference distance may be included in the metadata of the apparatus 1100. The apparatus 1100 may determine the gain of the object audio signal considering the air sound-absorption effect according to the distance. Medium attenuation may correspond to frequency-dependent attenuation of the sound source due to geometric energy diffusion. The apparatus 1100 may model the medium attenuation according to the air sound-absorption effect by modifying an EQ field in the distance stage 321. According to the medium attenuation due to the air sound-absorption effect, the apparatus 1100 may apply a low-pass filter effect to the audio object far from the listener. The sound level attenuation of the object audio signal according to the air sound-absorption effect may be determined differently for each frequency domain. For example, according to the distance between the audio object 490 and the listener 400, attenuation in a high frequency domain may be greater than attenuation in a low frequency domain. The attenuation rate may be defined differently depending on an environment such as temperature and humidity. When information such as temperature and humidity of an actual environment is not given or an attenuation constant due to air is calculated, it is difficult to accurately reflect the attenuation according to the actual air sound-absorption. The apparatus 1100 may apply the attenuation effects by air absorption using a parameter set for air sound-absorption included in the metadata.

An audio signal (e.g., a recording sound source 410) may be obtained by recording a sound source (e.g., an original sound source 401) in a field. The original sound source 401 may refer to an object or scene that may cause a sound. In the recording operation, since the recording sound source 410 may have complex propagation characteristics according to the shape and radiation characteristics of the original sound source 401, it may be necessary to perform recording at an appropriate distance (e.g., a first distance) between the original sound source 401 and a recording apparatus 405. In case of the original sound source 401 with very loud sound, it may be necessary to set the first distance (e.g., a recording distance 403) in order to obtain an appropriate recording sound source, that is, the recording sound source 410. In case of the original sound source 401 (e.g., a thunder or airplane sound) that the recording apparatus 405 is unapproachable, the recording apparatus 405 may be located on the ground and the recording distance 403 may be separately estimated.

Since the sound may be attenuated in size or changed in tone by a medium (e.g., the air), the original sound source 401 and the recording sound source 410 may have differences in sound level and tone. For example, the attenuation effects (e.g., the attenuation of sound level or change in tone) (hereinafter, referred to as an air sound-absorption effect) by the air absorption corresponding to the recording distance 403 between the original sound source 401 and the recording apparatus 405 may be included in the recording sound source 410.

The object audio signal (e.g., a playback sound source 430) may be an audio played to the listener 400 in the 6DoF environment (e.g., the VR environment). The apparatus 1100 may generate the playback sound source 430 by rendering the recording sound source 410 based on the relationship (e.g., distance, presence or absence of obstacles, etc.) between the audio object 490 and the listener 400. For example, the apparatus 1100 may generate the playback sound source 430 by rendering the recording sound source 410 by performing application of the air sound-absorption effect corresponding to a second distance (e.g., the sound source distance 450) that is the distance between the audio object 490 and the listener 400.

The apparatus 1100 may generate the playback sound source 430 by rendering the recording sound source 410 based on Equation 2 below.

$$δ {L}_{t} ( f ) = α s \qquad [ Equation 2 ]$$

Here, f may denote an audio frequency, δLₜ may denote attenuation due to air sound-absorption, a may denote an attenuation coefficient due to air sound-absorption [dB/m], and s may denote a distance [m].

While the apparatus 1100 renders the recording sound source 410, the air sound-absorption effect corresponding to the recording distance 403 may overlap and apply to the original sound source 401. In the recording operation, the air sound-absorption effect according to the recording distance 403, which is the distance between the original sound source 401 and the recording apparatus 405, is included in the recording sound source 410, and since the apparatus 1100 generates the playback sound source 430 by rendering with the application of the air sound-absorption effect according to the sound source distance 450 to the recording sound source 410, the air sound-absorption effect corresponding to the recording distance 403 may overlap and apply to the original sound source 401. The attenuation of the sound level and the change effect of the tone of the original sound source 401 due to the air sound-absorption effect according to the recording distance 403 may overlap. In order to generate the accurate playback sound source 430, when the listener 400 is separated from the audio object 490 by the recording distance 403, it is necessary to play the original sound source 430 without a change instead of applying the air sound-absorption effect corresponding to the recording distance 403. In order to prevent and/or compensate for overlapping application of the air sound-absorption effect corresponding to the recording distance 403, the apparatus 1100 may define the recording distance 403 as a parameter and may use the recording distance 403 as a parameter in the rendering process. For example, the apparatus 1100 may add the recording distance 403 as a parameter to the EIF input of the encoder 200 of FIG. 2 and to a syntax of the bitstream to perform rendering.

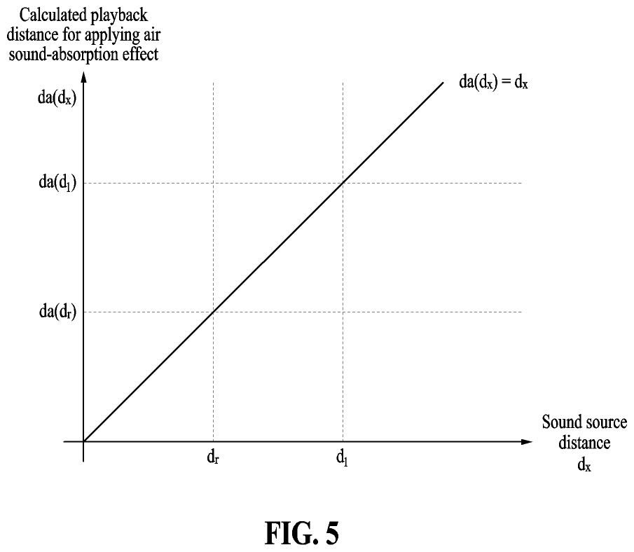

The apparatus 1100 may render the audio signal by adding two parameter (e.g., recDistance and recDUsage) fields for attributes of the sound source (e.g., the object sound source, channel sound source, and HOA sound source) to the EIF. recDistance may be a parameter related to a recording distance (e.g., the recording distance 403). recDistance may be defined in the same format as the reference distance. recDUsage may be a parameter indicating an application method of a recording distance. recDUsage may include a parameter (e.g., 0, 1) indicating two distance calculation methods that will be described with reference to FIGS. 5 to 11, and a parameter (e.g., 2, 3) indicating an application method of the recording distance to be used according to each manufacturer (e.g., a manufacturer of a renderer). Parameters added to the EIF for rendering by the apparatus 1100 considering the recording distance may be shown in Table 1 below.

TABLE 1

| Attribute | Type | Flags | Default | Description |
|---|---|---|---|---|
| refDistance | Float > 0 | ◯ | 1 | reference distance (m) |
| recDistance | Float > 0 | ◯ | 1 or | recording distance (m) |
| | | | refDistance | |
| recDUsage | Value | ◯ | 0 (method A) | method of applying |
| | | | | recording distance |
| | | | | 0: “method A” |
| | | | | 1: “method B” |
| | | | | 2, 3: “reserved” |

The apparatus 1100 may render the audio signal by adding a parameter related to the recording distance to the syntax of the bitstream and data structure. For example, the apparatus 1100 may add and use parameters (e.g., recDistance, recDUsage) related to the recording distance to the bitstream syntax of software (SW) used for rendering, as shown in Table 2 below.

TABLE 2

| Syntax | No. of bits | Mnemonic |
|---|---|---|
| audioStreams( ) | | |
| { | | |
| audioStreamsCount; | 16 | uimsbf |
| for (int i = 0; i < audioStreamsCount; i++) { | | |
| audioStreamId; | 16 | uimsbf |
| audioStreamFilePath; | 8..* | cstring |
| aepInputChannelsCount | 8 | uimsbf |
| for (int j = 0; j < aepInputChannelsCount; j++) | | |
| { | | |
| aepInputChannelIndex; | 8 | uimsbf |
| } | | |
| recDistance; | 10 | uimsbf |
| recDUsage | 2 | uimsbf |
| } | | |
| } | | |

recDistance is a parameter related to the recording distance and may include parameters (e.g., objectSourceRecDistance, hoaSourceRecDistance, and channelSourceRecDistance) for types of sound sources (e.g., the object sound source, HOA sound source, and channel sound source). recDistance is a parameter related to an application method of the recording distance and may include parameters (e.g., objectSourceRecDistance, hoaSourceRecDistance, and channelSourceRecDistance) for types of sound sources (e.g., the object sound source, HOA sound source, and channel sound source). The data structure for each parameter is shown in Table 3 below.

TABLE 3

| | | |
|---|---|---|
| objectSourceRecDistance; | 10 | uimsbf |
| objectSourceRecDUsage; | 2 | uimsbf |
| hoaSourceRecDistance; | 10 | uimsbf |
| hoaSourceRecDusage; | 2 | uimsbf |
| channelSourceRecDistance; | 10 | uimsbf |
| channelSourceRecDUsage; | 2 | uimsbf |

SourceRecDistance is a recording distance that is the distance between the sound source and the recording apparatus, and may be used for an air sound-absorption EQ. SourceRecDistance has a value between 0.0 and 2^{noOfBits}−1 (e.g., 1,023.0), and the apparatus 1100 may use Equation 3 below to quantize the value of SourceRecDistance into a floating point value.

$$floatVal = \sim SourceRecDistance \qquad [ Equation 3 ]$$

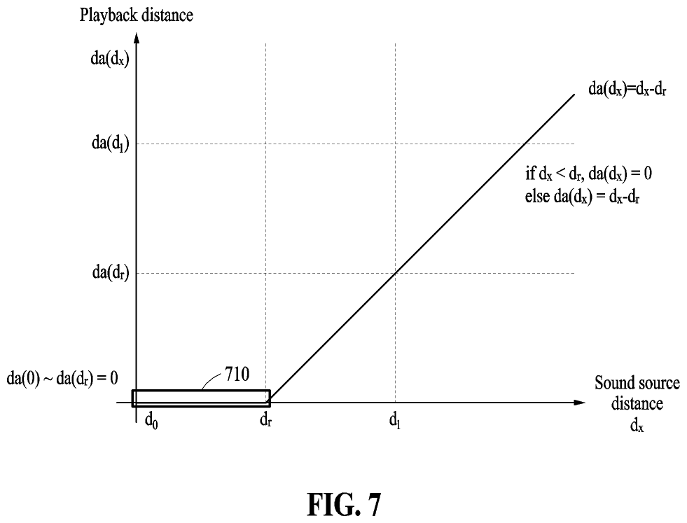

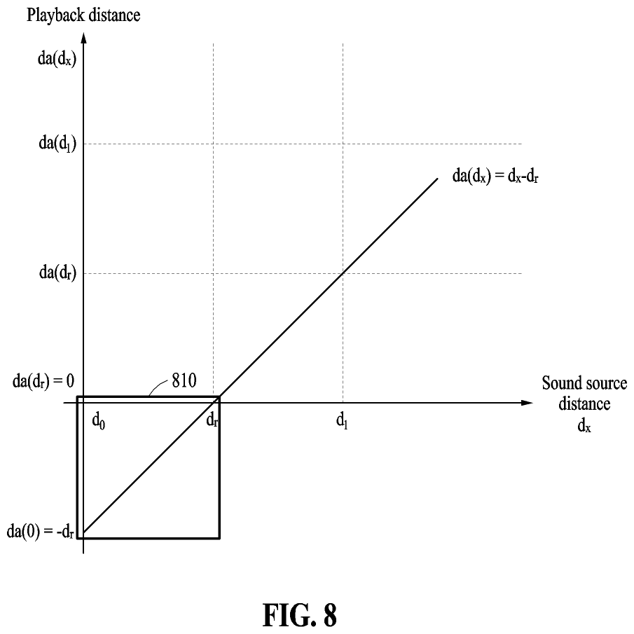

Depending on the application method of the recording distance, SourceRecDUsage may have a value (e.g., CONSTEQ) corresponding to a method (e.g., a method A of FIG. 7) of preventing the air sound-absorption effect within the recording distance, a value (e.g., COMPEQ) corresponding to a method (e.g., a method B of FIG. 8) of compensating for the air sound-absorption effect within the recording distance, or a value (e.g., RESERVED) according to the application method of the recording distance to be used according to each manufacturer's renderer. The values of SourceRecDUsage are shown in Table 4 below.

TABLE 4

| bits | usageType |
|---|---|
| 0b00 | CONSTEQ |
| 0b01 | COMPEQ |
| 0b10 | RESERVED |
| 0b11 | RESERVED |

FIG. 5 is a diagram illustrating an embodiment of calculating a distance for application of an air sound-absorption effect.

Referring to FIG. 5, according to an embodiment, in the conventional MPEG-I immersive audio renderer (RM0)-based technology, in application of the air sound-absorption effect, a sound source distance (e.g., the sound source distance 450 of FIG. 4) is used without a change instead of considering a recording distance (e.g., the recording distance 403 of FIG. 4). When a distance (e.g., the sound source distance 450) from an audio object to a listener is dₓ, a recording distance (e.g., the recording distance 403 of FIG. 4) is dᵣ, and a distance (e.g., the third distance) used to perform the application of the air sound-absorption effect is da(dᵣ), the conventional RM0 renderer uses the equation da(dₓ)=dₓ to use the sound source distance as the third distance (e.g., a playback distance (e.g., the distance s in Equation 2)) without a change instead of considering the recording distance.

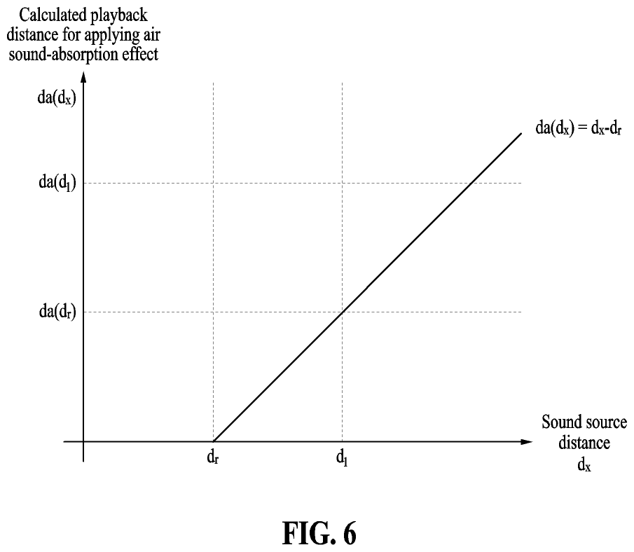

FIG. 6 is a diagram illustrating an embodiment of calculating a distance for application of an air sound-absorption effect considering a recording distance.

Referring to FIG. 6, according to an embodiment, as described with reference to FIG. 4, it may be necessary to render an audio signal (e.g., the recording sound source 410) such that an air sound-absorption effect during a recording process may not overlap. Therefore, in order to prevent and/or compensate for the overlapping application of the air sound-absorption effect when the sound source distance dₓ is within the recording distance dᵣ, modifications to the calculation of the playback distance da(dₓ) may be necessary. For example, the apparatus 1100 may derive a playback distance for application of an air sound-absorption effect using Equation 4 that introduces a recording distance.

$$da ( {d}_{x} ) = {d}_{x} - {d}_{r} \qquad [ Equation 4 ]$$

FIGS. 7 and 8 are diagrams illustrating methods of calculating a distance (e.g., a third distance) for application of an air sound-absorption effect according to an embodiment. The distance calculation methods described with reference to FIGS. 7 and 8 may be selectively performed by the apparatus 1100 of FIG. 11 during the rendering process of an object audio signal.

Referring to FIG. 7, according to an embodiment, FIG. 7 may be a diagram illustrating a method (hereinafter, referred to as method A) of preventing an air sound-absorption effect within a recording distance. The apparatus 1100 may select the method A to render an object audio signal by the application of the air sound-absorption effect considering a recording distance. The method A may be a method of calculating a third distance (e.g., a playback distance dₐ(dₓ)) by dividing a range of sound source distances in calculating a distance (e.g., the third distance) for the application of the air sound-absorption effect. The method A may be a method of setting the playback distance dₐ(dₓ) to 0 m in a range 710 where the sound source distance dₓ is less than the recording distance dᵣ and calculating the playback distance dₐ(dₓ) using Equation 4 for the sound source distance of the range excluding the range 710. When the apparatus 1100 selects the method A to render the object audio signal, within the distance less than the recording distance, an original sound source (e.g., the original sound source 401 of FIG. 4) may be used as the object audio signal (e.g., the playback sound source 430 of FIG. 4) without a change.

Referring to FIG. 8, according to an embodiment, FIG. 8 may be a diagram illustrating a method (hereinafter, referred to as method B) of compensating for an air sound-absorption effect within a recording distance. The apparatus 1100 may select the method B to render the object audio signal by application of the air sound-absorption effect considering the recording distance. The method B may be a method of using Equation 4 for all ranges of sound source distances in calculating the third distance (e.g., the playback distance dₐ(dₓ)). For example, in the method B, in the range 810 where the sound source distance dₓ is less than the recording distance dᵣ, since the playback distance dₐ(dₓ) calculated according to Equation 4 becomes a negative number, the method B may be a method of compensating for a low-pass filter effect due to the air sound-absorption by using the negative distance as the playback distance dₐ(dₓ).

For convenience of explanation, it is assumed that the recording sound source is obtained by recording at the recording distance of 90 m with respect to the jet sound-source of a battle scene, which is one of the MPEG-I immersive audio call for proposal (CfP) test scenes. For the recording distance of 90 m, the attenuation by air absorption according to methods A and B may be shown in Tables 5 and 6 below.

TABLE 5

| | | Attenuation by Air Absorption [dB] | | | | |
|---|---|---|---|---|---|---|
| Sound Source | | for Each Center Frequency Band | | | | |
| Distance dₓ | | 100[Hz] | 500[Hz] | 1,000[Hz] | 5,000[Hz] | 10,000[Hz] |
| 1,090 | m | 0.351 | 2.63 | 4.65 | 55.1 | 194 |
| 180 | m | 0.03159 | 0.2367 | 0.4185 | 4.959 | 17.46 |
| 90 | m | 0 | 0 | 0 | 0 | 0 |
| 0 | m | 0 | 0 | 0 | 0 | 0 |

TABLE 6

| | | Attenuation by Air Absorption [dB] | | | | |
|---|---|---|---|---|---|---|
| Sound Source | | for Each Center Frequency Band | | | | |
| Distance dₓ | | 100[Hz] | 500[Hz] | 1,000[Hz] | 5,000[Hz] | 10,000[Hz] |
| 1,090 | m | 0.351 | 2.63 | 4.65 | 55.1 | 194 |
| 180 | m | 0.03159 | 0.2367 | 0.4185 | 4.959 | 17.46 |
| 90 | m | 0 | 0 | 0 | 0 | 0 |

| | | | | | |
|---|---|---|---|---|---|
| 0 m (Compensated | −0.03159 | −0.2367 | −0.4185 | −4.959 | −17.46 |
| Attenuation Coefficient) | | | | | |

In Tables 5 and 6, the air sound-absorption attenuation coefficient used a value at a temperature of 20 degree Celsius (° C.), a humidity of 40 percent (%), and an atmospheric pressure of 101.325 kilopascal (kPa) according to international organization for standardization (ISO) 9613-1. The attenuation by air absorption according to the sound source distance dx may be calculated using Equation 5 below.

$$Attenuation at {d}_{x} [ m ] = ( Attenuation Coefficient at 1 , 000 m ) \times \frac{{d}_{x}}{1 , 000} \qquad [ Equation 5 ]$$

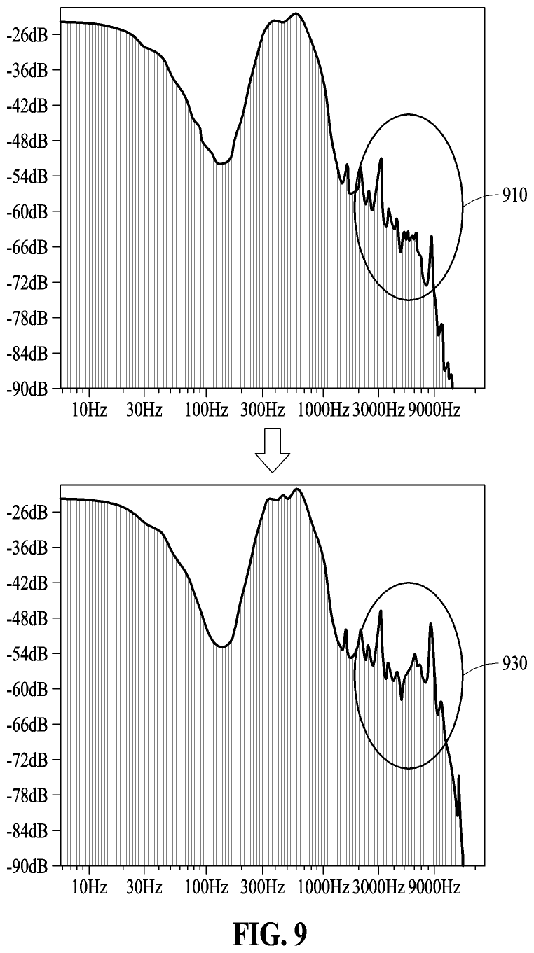

FIG. 9 illustrates the spectrum of an audio signal before and after application of an audio rendering method according to an embodiment.

Referring to FIG. 9, according to an embodiment, FIG. 9 may be a diagram showing the result of rendering the object audio signal in terms of a spectrum using the method B described with reference to FIG. 8. It is assumed that the recording sound source is obtained by performing recording at the recording distance of 90 m with respect to the jet sound-source of a battle scene, which is one of the MPEG-I immersive audio CfP test scenes. The apparatus 1100 may select the method A or the method B to perform application of the air sound-absorption effect considering the recording distance. If the sound source distance dₓ is 0 m when the apparatus 1100 selects the method B to render the recording sound source, the apparatus 1100 may compensate for the air sound-absorption effect according to a negative distance for the range from 0 m to the recording distance of 90 m. When the air sound-absorption effect is compensated for according to the negative distance, there may be a distinct difference in a high frequency band (e.g., a band of 3 kilohertz (kHz) or more). For example, compared to a spectrum 910 of the high frequency band before compensating for the air sound-absorption effect with the negative distance, it may be confirmed that a spectrum 930 of the high frequency band after compensating for the negative distance is clearly distinguished.

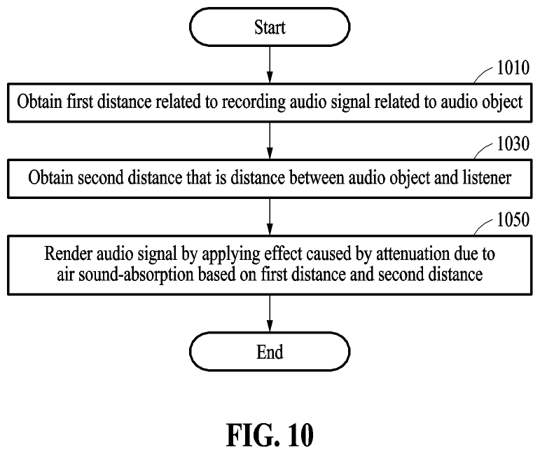

FIG. 10 is a flowchart illustrating a method of rendering an audio signal, according to an embodiment. Operations 1010 to 1050 may be substantially the same as the audio signal rendering method used by the apparatus described with reference to FIGS. 4 to 11 (e.g., the apparatus 1100 of FIG. 11).

In operation 1010, the apparatus 1100 may obtain a first distance (e.g., a recording distance) related to recording of an audio signal related to an audio object.

In operation 1030, the apparatus 1100 may obtain a second distance (e.g., a sound source distance) that is a distance between the audio object and a listener.

In operation 1050, the apparatus 1100 may render the audio signal by applying an effect caused by attenuation due to air sound-absorption based on the first distance and the second distance.

Operations 1010 to 1050 may be performed sequentially but are not limited thereto. For example, two or more operations may be performed in parallel.

FIG. 11 is a schematic block diagram of an apparatus according to an embodiment.

Referring to FIG. 11, according to an embodiment, the apparatus 1100 may perform the audio rendering method described with reference to FIGS. 1 to 11. The apparatus 1100 may include a memory 1110 and a processor 1130.

The memory 1110 may store instructions (or programs) executable by the processor 1130. For example, the instructions may include instructions for performing an operation of the processor 1130 and/or an operation of each component of the processor 1130.

The memory 1110 may include one or more of computer-readable storage media. The memory 1110 may include non-volatile storage elements (e.g., a magnetic hard disk, an optical disc, a floppy disc, flash memory, erasable programmable read-only memory (EPROM), and electrically erasable programmable read-only memory (EEPROM)).

The memory 1110 may be a non-transitory medium. The term “non-transitory” may indicate that the storage medium is not embodied in a carrier wave or a propagated signal. However, the term “non-transitory” should not be interpreted to mean that the memory 1210 is non-movable.

The processor 1130 may process data stored in the memory 1110. The processor 1130 may execute computer-readable code (e.g., software) stored in the memory 1110 and instructions triggered by the processor 1130.

The processor 1130 may be a hardware-implemented data processing device having a circuit that is physically structured to execute desired operations. For example, the desired operations may include code or instructions included in a program. For example, the hardware-implemented data processing device may include, for example, a microprocessor, a CPU, a processor core, a multi-core processor, a multiprocessor, an ASIC, and an FPGA.

The operations performed by the processor 1130 may be substantially the same as the audio rendering method according to an embodiment described with references to FIGS. 1 to 11. Accordingly, a detailed description thereof is omitted.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of the processing device is singular; however, one of ordinary skill in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or one or more combinations thereof, to independently or collectively instruct or configure the processing device to operate as desired. Software and/or data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the embodiments may be recorded in non-transitory computer-readable media including program instructions to implement various operations of the embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc-read only memory (CD-ROM) and digital video discs (DVDs); magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

The above-described hardware devices may be configured to act as one or more software modules in order to perform the operations of the above-described embodiments, or vice versa.

Although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

1. An audio rendering method comprising:
obtaining a first distance related to recording of an audio signal related to an audio object;
obtaining a second distance that is a distance between the audio object and a listener; and
rendering the audio signal by applying an effect caused by attenuation due to air sound-absorption based on the first distance and the second distance.

2. The audio rendering method of claim 1, wherein
the rendering comprises:
calculating a third distance based on a difference between the first distance and the second distance; and
rendering the audio signal by applying the effect caused by the attenuation due to the air sound-absorption based on the third distance.

3. The audio rendering method of claim 2, wherein
the calculating of the third distance comprises calculating the third distance by reducing the second distance by the first distance.

4. The audio rendering method of claim 2, wherein
the calculating of the third distance comprises calculating the third distance differently based on the difference between the first distance and the second distance.

5. The audio rendering method of claim 4, wherein
the calculating of the third distance differently comprises:
calculating the third distance as a predetermined value when the second distance is less than or equal to the first distance; and
calculating the third distance by reducing the second distance by the first distance when the second distance is greater than the first distance.

6. The audio rendering method of claim 1, wherein
the first distance comprises a distance between a sound source to be recorded and a recording apparatus.

7. The audio rendering method of claim 1, wherein
the rendering comprises rendering the audio signal by compensating for tone by a size of the effect caused by the attenuation due to the air sound-absorption, when the second distance is less than the first distance.

8. A non-transitory computer-readable storage medium storing instructions that, when executed by a processor, cause the processor to perform the method of any one of claims 1 to 7.

9. An audio rendering apparatus comprising:
a memory configured to store instructions; and
a processor electrically connected to the memory and configured to execute the instructions,
wherein the processor is configured to control a plurality of operations, when the instructions are executed by the processor,
wherein the plurality of operations comprises:
obtaining a first distance related to recording of an audio signal related to an audio object;
obtaining a second distance that is a distance between the audio object and a listener; and
rendering the audio signal by applying an effect caused by attenuation due to air sound-absorption based on the first distance and the second distance.

10. The audio rendering apparatus of claim 9, wherein
the rendering comprises:
calculating a third distance based on a difference between the first distance and the second distance; and
rendering the audio signal by applying the effect caused by the attenuation due to the air sound-absorption based on the third distance.

11. The audio rendering apparatus of claim 10, wherein
the calculating of the third distance comprises calculating the third distance by reducing the second distance by the first distance.

12. The audio rendering apparatus of claim 10, wherein
the calculating of the third distance comprises calculating the third distance differently based on the difference between the first distance and the second distance.

13. The audio rendering apparatus of claim 12, wherein
the calculating of the third distance differently comprises:
calculating the third distance as a predetermined value when the second distance is less than or equal to the first distance; and
calculating the third distance by reducing the second distance by the first distance when the second distance is greater than the first distance.

14. The audio rendering apparatus of claim 9, wherein
the first distance comprises a distance between a sound source to be recorded and a recording apparatus.

15. The audio rendering apparatus of claim 9, wherein
the rendering comprises rendering the audio signal by compensating for tone by a size of the effect caused by the attenuation due to the air sound-absorption, when the second distance is less than the first distance.
